(19) United States
(12) Patent Application Publication
(10) Pub. No.: US 2015/0305970 A1
(43) Pub. Date: Oct. 29, 2015

(54) JIM ROLLER

(71) Applicant: Lawrence Lucey, Wilmette, IL (US)

(72) Inventor: Lawrence Lucey, Wilmette, IL (US)

(21) Appl. No.: 14/694,613

(22) Filed: Apr. 23, 2015

Related U.S. Application Data
(60) Provisional application No. 61/983,780, filed on Apr. 24, 2014.

(51) Int. Cl. A61H 15/00

(52) U.S. Cl. CPC A61H 15/0092; A61H 2015/0014

(57) ABSTRACT

Embodiments of the invention relate to a medical roller device. The medical roller device includes a shaft having a first end and a second end opposite the first end; a roller rotatably connected to the first end of the shaft; and a securement mechanism connected to the second end of the shaft.

### CROSS REFERENCE TO RELATED APPLICATION

This application claims the benefit of U.S. Provisional Application No. 61/983,780 filed Apr. 24, 2014 titled “Jim Roller” the complete subject matter of which is incorporated herein by reference.

### FIELD OF THE INVENTION

The invention relates to a medical device. More specifically, it relates to a rolling medical device used to prevent or treat injuries.

### BACKGROUND OF THE INVENTION

The Iliotibial Band is a thick band of fibrous tissue running down the outside of the leg, connecting the hip to the knee, and is crucial to stabilizing the knee. Injury to that area is known as Iliotibial Band Syndrome (IBS), which is a well known injury suffered by runners, cyclists, weight-lifters, and the like. Treatment includes applying pressure to the afflicted area. Generally, a physical therapist uses a roller, applying pressure to the injured area by placing the roller on the injured area and applying pressure using their forearms while rolling the roller back and forth. While such treatment works well when therapists are available, it becomes difficult when the injured person is alone. By oneself, the injured person places the roller on the ground and lays on it. Such arrangement requires balance and can place too much pressure on the injured area. Roller devices similar to rolling pins have been used, but this requires the injured person to contort his back to apply pressure to the proper area.

Accordingly, it is an object of the present invention to provide a rolling medical device that places the proper amount of pressure on the injured area, but without requiring the injured person to contort themselves to apply such pressure. Further such rolling device should be inexpensive to make and easy to pack for travel.

These and other objects will be readily evident upon a study of the specification and the accompanying drawing wherein:

### SUMMARY OF THE INVENTION

Embodiments of the invention relate to a medical roller device. The medical roller device includes a shaft having a first end and a second end opposite the first end; a roller rotatably connected to the first end of the shaft; and a securement mechanism connected to the second end of the shaft.

Another embodiment relates to a medical roller device. The medical roller device includes a shaft having a first end and a second end opposite the first end; a roller rotatably connected to the first end of the shaft; a locking/unlocking device proximate the roller; and a securement mechanism connected to the second end of the shaft.

Still another embodiment relates to a medical roller device. The medical roller device includes a shaft having a first end and a second end opposite end and at least one branch support member; a roller rotatably connected proximate the at least one branch support member; a locking/unlocking device proximate the roller; and a securement mechanism connected to the second end of the shaft.

Still other embodiments include a handle positioned on the shaft located between the first end and the second end. Embodiments may include the securement device selected from a group comprising including a half-circle bracket, a strap and a cuff; and/or the locking/unlocking device is selected from a group including a removable end cap and a bend and removable loop arrangement. Embodiments of the medical roller device may include a handgrip. Embodiments may include one, two or more branch support members proximate the roller, with a crossover member proximate the roller and connected to the at least one branch support member.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting the scope of the invention being defined by the appended claims and equivalents thereof.

### BRIEF DESCRIPTION OF THE DRAWINGS

FIG. 1 is a front view of the roller device in accordance with one embodiment of the present invention;

FIG. 2 is a side view of the roller device of FIG. 1 of the present invention;

FIG. 3 is a front view of the roller device in accordance with another embodiment of the present invention;

FIG. 4 is a partial exploded view of the roller device of FIG. 3 of the present invention;

FIG. 5 is a front view of the roller device in accordance with still another embodiment of the present invention;

FIG. 6 is a side view of the roller device of FIG. 5 of the present invention;

FIG. 7 is a front view of the roller device in accordance with yet still another embodiment of the present invention;

FIG. 8 is a side view of the roller device of FIG. 7 of the present invention; and

FIG. 9 is a front view of the roller device in accordance with one embodiment of the present invention; and

FIG. 10 is another front view of the roller device of FIG. 9 of the present invention.

Throughout the various figures, like reference numbers refer to like elements.

### DETAILED DESCRIPTION OF PRESENTLY PREFERRED EMBODIMENTS

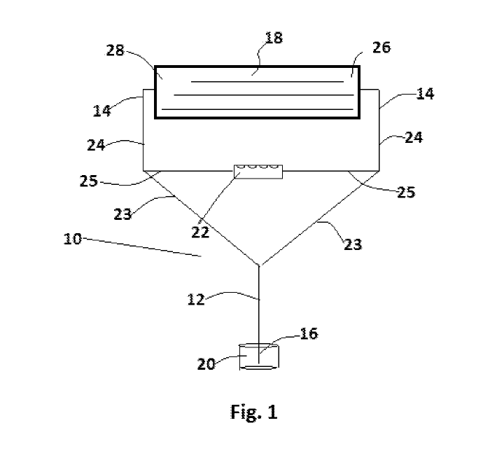

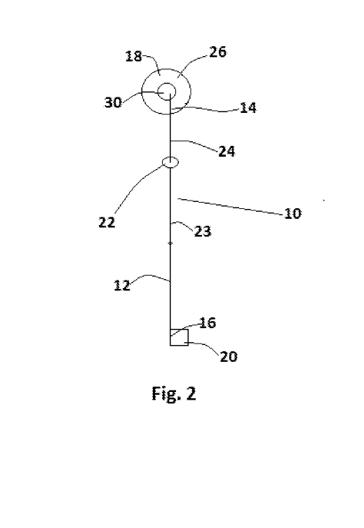

Embodiments of the invention relate to an apparatus and method for a medical roller device, generally designated 10 in FIGS. 1-2. The medical roller device 10 includes a shaft 12 having a first end 14 and a second end 16 opposite the first end 14. The medical roller device 10 further includes a roller 18 rotatably connected to the first end 14 of the shaft 12. One or more embodiments includes a securement mechanism 20 connected to the second end 16 of the shaft 12.

As illustrated in FIGS. 1-2, the medical roller device 10 includes at least one but generally two offset shafts comprised of first branch portion 23 proximate and connected to shaft 12 and a second branch portion 24 proximate to first end 14 and connected to roller 18. In the illustrated embodiment, the first branch portion 23 is offset from and at an angle to shaft 12 while second branch portion 24 is offset from and at an angle to first branch portion, such that second branch portion 24 is substantially parallel to shaft 12. As illustrated, the medical roller device 10 further includes a crossover or support member 25 connecting the two offset shafts proximate at least one of the first branch portion 23 and the second branch portion 24 providing support to the two offset shafts.

In the illustrated embodiment, handle or grip 22 is attached to or positioned on the crossover or support member 25 midway between the two offset shafts. In other embodiments, the grip 22 could be positioned on shaft 12 for example. In at least one embodiment, the roller 18 has a first end 26 and a second end 28 opposite the first end 26, where the roller 18 defines a bore extending between the first end 26 and second end 28.

FIG. 2 depicts the roller 18 having a locking/unlocking device or feature such as an end cap 30 frictionally fit within the bore at first end 26, where the end cap 30 rotatably engages the at least one divergent or offset shaft portion 24. Such arrangement allows the roller 18 to be removed from the least one divergent or offset shaft portion 24, allowing the roller 18 to be replaced or allow the medical roller device 10 to be packed away for travel or storage. Additionally, the roller 18 may have a smooth surface or a knobby surface. Furthermore, the shaft 12 may be one size or extendable moving between a first position and a second position.

As illustrated, medical device 10 includes a securement mechanism 20. In the illustrated embodiment, the securement mechanism 20 includes a half-circle bracket, positioned on one side of shaft 12 best illustrated in FIG. 2. The securement mechanism 20 provides leverage. Although a half-circle bracket is shown, other securement mechanisms 20 are contemplated.

In operation, the user slides their hand through the securement mechanism so that the shaft 12 rests on the upper surface of the user's arm. The user than reaches and grabs the handle 22. In this manner the user is able to place the roller 18 on the injured area and provide the proper amount of pressure to the injured area, without requiring the injured person to contort themselves to apply such pressure.

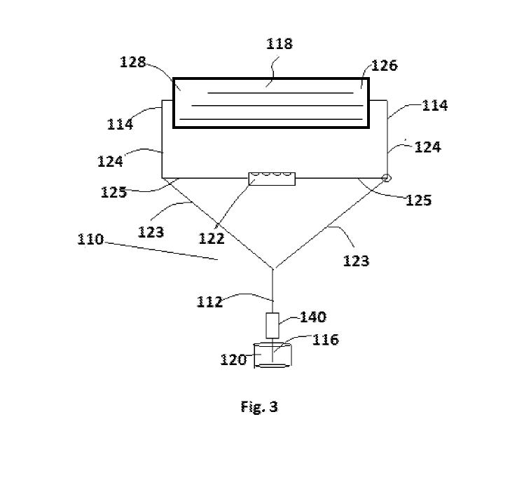

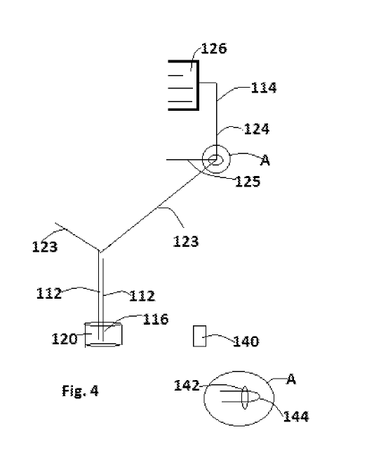

Embodiments of the invention relate to an apparatus and method for a medical roller device, generally designated 110 in FIGS. 3-4, where FIG. 4 is a partial view of the roller device of FIG. 3. The medical roller device 110 includes a shaft 112 having a first end 114 and a second end 116 opposite the first end 114. The medical roller device 110 further includes a roller 118 rotatably connected to the first end 114 of the shaft 112. One or more embodiments includes a securement mechanism 120 connected to the second end 116 of the shaft 112.

As illustrated in FIGS. 3-4, the medical roller device 110 includes at least one but generally two offset shafts comprised of first branch portion 123 proximate and connected to shaft 112 and a second branch portion 124 proximate to first end 114 and connected to roller 118. In the illustrated embodiment, the first branch portion 123 is offset from and at an angle to shaft 112 while second branch portion 124 is offset from and at an angle to first branch portion, such that second branch portion 124 is substantially parallel to shaft 112. As illustrated, the medical roller device 110 further includes a crossover or support member 125 connecting the two offset shafts proximate at least one of the first branch portion 123 and the second branch portion 124 providing support to the two offset shafts.

As illustrated, handle or grip 122 is attached to or positioned on the crossover or support member 125 midway between the two offset shafts. In other embodiments, the grip 122 could be positioned on shaft 112 for example. In at least one embodiment, the roller 118 has a first end 126 and a second end 128 opposite the first end 126, where the members, each member having a flat opposing inside surface held in place by sleeve 140. As shown in FIG. 4, one of the members in shorter than the other member, allowing the sleeve 140 to be moved away from end 116, removed and the members separate.

FIG. 4 further includes an eyelet or loop 142 defined by at least one of the first branch portion 123 and second branch portion 124, best viewed in enlarged detail A. In this embodiment, crossover member 125 defines a locking/unlocking device such as a bend 144 adapted to be removably received in loop 142. To remove and replace roller 118 sleeve 140 is moved away from end 116. The sleeve 140 is removed, which allows the members of the shaft 112 to separate. This allows the bend 144 to move out of loop 142. The roller 118 can then be removed and replaced.

As illustrated in FIGS. 3-4, the medical roller device 110 includes a handle or grip 122. In one or more embodiments, the medical roller device 110 includes two divergent or offset shaft portions 124 rotatably connected to the roller 118, wherein the divergent or offset shaft portions 124 are offset from at least one axis defined by the shaft 112. In the illustrated embodiment, handle or grip 112 is positioned on offset shaft portion 124 at the connection of shaft 112 and shaft portion 124 but could be positioned on shaft 112 for example. In at least one embodiment, the roller 118 has a first end 126 and a second end 128 opposite the first end 126, where the roller 118 defines a bore extending between the first end 126 and second end 128.

FIG. 4 depicts the roller 118 having a smooth surface. However roller 118 may have a knobby surface or any other surface. The shaft 112 may be one size or extendable between a first position and a second position.

As illustrated, medical device 110 includes a securement mechanism 120. In the illustrated embodiment, the securement mechanism 120 includes a strap or cuff, positioned on one side of shaft 112. The securement mechanism 120 provides leverage. Although a strap or cuff 120 is shown, other securement mechanisms 120 are contemplated.

In operation, the user slides their hand through the securement mechanism so that the shaft 112 rests on the upper surface of the user's arm. The user than reaches and grabs the handle 122. In this manner the user is able to place the roller 118 on the injured area and provide the proper amount of pressure to the injured area, without requiring the injured person to contort themselves to apply such pressure.

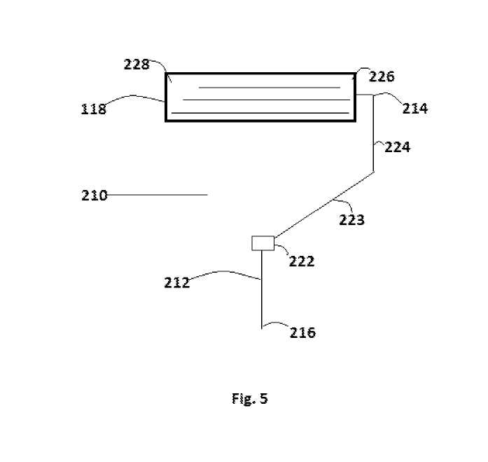

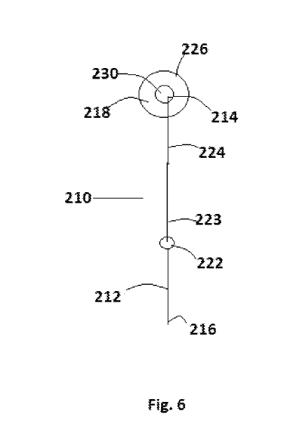

Embodiments of the invention further relate to an apparatus and method for a medical roller device, generally designated 210 in FIGS. 5-6. As illustrated, the medical roller device 210 includes at least one offset shaft comprised of first branch portion 223 proximate and connected to shaft 212 and a second branch portion 224 proximate to first end 214 and connected to roller 2118. In the illustrated embodiment, the first branch portion 223 is offset from and at an angle to shaft 212 while second branch portion 224 is offset from and at an angle to first branch portion, such that second branch portion 224 is substantially parallel to shaft 212. As illustrated, the medical roller device 210 includes a handle or grip 222. In at least one embodiment, the roller 218 has a first end 226 and a second end 228 opposite the first end 226, where the roller 218 defines a bore extending between the first end 226 and second end 228.

FIG. 6 depicts the roller 218 having a locking/unlocking device such as end caps 230 frictionally fit within the bore at first end 226 and second end 228, where the end caps 230 rotatably engage the divergent or offset shaft portion 224. Such arrangement allows the roller 218 to be removed from divergent or offset shaft portion 224, allowing the roller 218 to be replaced and/or allow the medical roller device 210 to be packed away for travel or storage. Additionally, the roller 218 may have a smooth surface or a knobby surface. Additionally, the shaft 212 may be one size or extendable between a first position and a second position.

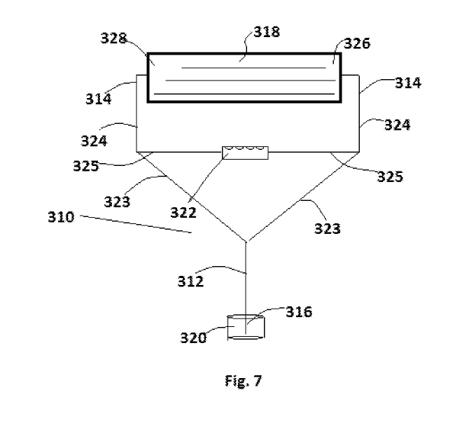

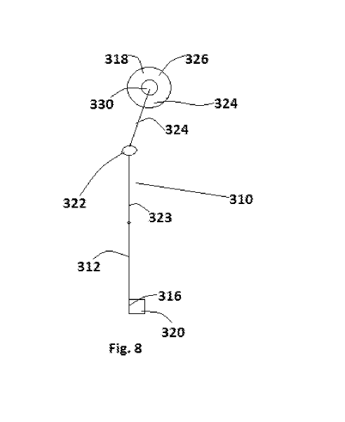

Embodiments of the invention relate to an apparatus and method for a medical roller device, generally designated 310 in FIGS. 7-8. The medical roller device 310 includes at least one but generally two offset shafts comprised of first branch portion 323 proximate and connected to shaft 312 and a second branch portion 324 proximate to first end 314 and connected to roller 318. In the illustrated embodiment, the first branch portion 323 is offset from and at an angle to shaft 312 while second branch portion 324 is offset from and at an angle to first branch portion, such that second branch portion 324 is substantially parallel to shaft 312. As illustrated, the medical roller device 310 further includes a crossover or support member 325 connecting the two offset shafts proximate at least one of the first branch portion 323 and the second branch portion 324 providing support to the two offset shafts.

In the illustrated embodiment, handle or grip 322 is attached to or positioned on the crossover or support member 325 midway between the two offset shafts. In other embodiments, the grip 322 could be positioned on shaft 312 for example. In at least one embodiment, the roller 318 has a first end 326 and a second end 328 opposite the first end 326, where the roller 318 defines a bore extending between the first end 326 and second end 328.

FIG. 8 depicts the medical roller device 310 is angled to provide more pressure to the injured area. More specifically second branch portion 324 is offset from or on a different plane from that defined by at least first branch portion 323. FIG. 8 depicts the roller 318 having a locking/unlocking device such as end caps 330 frictionally fit within the bore at first end 326 and second end 328, where the end caps 330 rotatably engage the divergent or offset shaft portions 324. Such arrangement allows the roller 318 to be removed from divergent or offset shaft portions 324, allowing the roller 318 to be replaced and/or allow the medical roller device 310 to be packed away for travel or storage. Additionally, the roller 318 may have a smooth surface or a knobby surface. Furthermore, the shaft 312 may be one size or extendable between moving between a first position and a second position.

As illustrated, medical device 310 includes a securement mechanism 320. In the illustrated embodiment, the securement mechanism 320 includes a strap or cuff. The securement mechanism 320 provides leverage. Although a strap or cuff 320 is shown, other securement mechanisms are contemplated.

In operation, the user slides their hand through the securement mechanism so that the shaft 312 rests on the upper surface of the user's arm. The user than reaches and grabs the handle 322. In this manner the user is able to place the roller 318 on the injured area and provide the proper amount of pressure to the injured area, without requiring the injured person to contort themselves to apply such pressure.

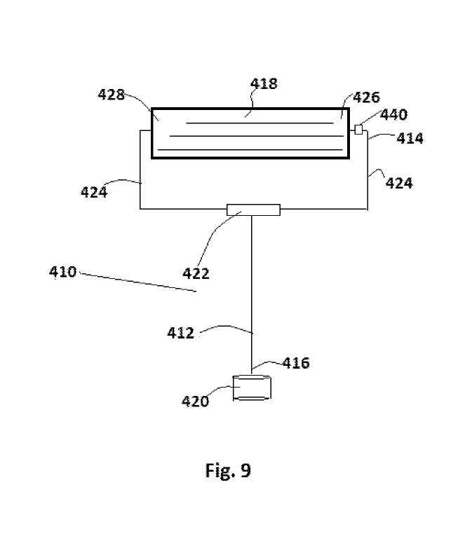

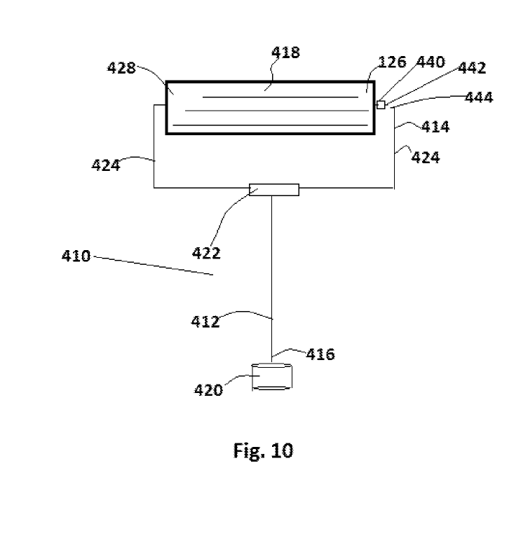

Embodiments of the invention relate to an apparatus and method for a medical roller device, generally designated 410 in FIGS. 9-10. The medical roller device 410 includes a shaft 412 having a first end 414 and a second end 416 opposite the first end 414. The medical roller device 410 further includes a roller 418 rotatably connected to the first end 414 of the shaft 412. One or more embodiments includes a securement mechanism 420 connected to the second end 416 of the shaft 412.

As illustrated in FIGS. 9-10, the medical roller device 410 includes a handle or grip 422. In one or more embodiments, the medical roller device 410 includes two divergent or offset shaft portions 424 rotatably connected to the roller 418, wherein the divergent or offset shaft portions 424 are offset from at least one axis defined by the shaft 412. In the illustrated embodiment, the roller 418 has a first end 426 and a second end 428 opposite the first end 426, where the roller 418 defines a bore extending between the first end 426 and second end 428.

FIGS. 9-10 depict the roller 418 having a locking/unlocking feature. Such arrangement allows the roller 418 to be removed from divergent or offset shaft portions 424, allowing the roller 418 to be replaced and/or allow the medical roller device 410 to be packed away for travel or storage.

In the illustrated embodiment the locking feature includes slidably threaded portion 440 and two flat portions 442 and 444 that overlay each other such that flat portion 442 may rest on portion 444 for example and have reciprocal threads to receive threaded portion 440 in an overlaying fashion. FIG. 9 illustrates the two flat portions 442 and 444, where portion 442 rests upon portion 444 and is threadably engaged by portion 440. FIG. 10 illustrates portion 440 disengaged from flat portions 442 and 444, such that flat portions 442 and 444 are in an unengaged, open position allowing roller 418 to be removed and replaced. Although two flat portions 442 and 444 and threaded portion 440 are discussed, other means are contemplated. Additionally, the shaft 412 may be one size or extendable between moving between a first position and a second position.

As illustrated, medical device 410 includes a securement mechanism 420. In the illustrated embodiment, the securement mechanism 420 includes a strap or cuff. The securement mechanism 420 provides leverage. Although a strap or cuff is shown, other securement mechanisms are contemplated.

In operation, the user slides their hand through the securement mechanism so that the shaft 412 is positioned against the lower surface of the user's arm. The user than reaches and grabs the handle 422. In this manner the user is able to place the roller 418 on the injured area and provide the proper amount of pressure to the injured area, without requiring the injured person to contort themselves to apply such pressure.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A medical roller device comprising:
a shaft having a first end and a second end opposite the first end;
a roller rotatably connected to the first end of the shaft; and
a securement mechanism connected to the second end of the shaft.

2. The medical roller device of claim 1 further comprising a handle positioned on the shaft located between the first end and the second end.

3. The medical roller device of claim 1 wherein the securement device is selected from a group comprising a half-circle bracket, a strap and a cuff.

4. The medical roller device of claim 1 further including a locking/unlocking device.

5. The medical roller device of claim 4 wherein the locking/unlocking device is selected from a group comprising a removable end cap and a bend and removable loop arrangement.

6. The medical roller device of claim 1 further comprising a handgrip.

7. The medical roller device of claim 1 further comprising at least one branch support member proximate the roller.

8. The medical roller device of claim 7 further comprising a crossover member proximate the roller and connected to the at least one branch support member.

9. A medical roller device comprising:
a shaft having a first end and a second end opposite the first end;
a roller rotatably connected to the first end of the shaft;
a locking/unlocking device proximate the roller; and
a securement mechanism connected to the second end of the shaft.

10. The medical roller device of claim 9 further comprising a handle positioned on the shaft located between the first end and the second end.

11. The medical roller device of claim 9 wherein the securement device is selected from a group comprising a half-circle bracket, a strap and a cuff.

12. The medical roller device of claim 9 wherein the locking/unlocking device is selected from a group comprising a removable end cap and a bend and removable loop arrangement.

13. The medical roller device of claim 9 further comprising at least one branch support member proximate the roller.

14. The medical roller device of claim 13 further comprising a crossover member proximate the roller and connected to the at least one branch support member.

15. A medical roller device comprising:
a shaft having a first end and a second end opposite end and at least one branch support member;
a roller rotatably connected proximate the at least one branch support member;
a locking/unlocking device proximate the roller; and
a securement mechanism connected to the second end of the shaft.

16. The medical roller device of claim 15 further comprising a handle positioned on the shaft located between the first end and the second end.

17. The medical roller device of claim 16 wherein the securement device is selected from a group comprising a half-circle bracket, a strap and a cuff.

18. The medical roller device of claim 17 wherein the locking/unlocking device is selected from a group comprising a removable end cap and a bend and removable loop arrangement.

19. The medical roller device of claim 18 further comprising two branch support members.

20. The medical roller device of claim 19 further comprising a crossover member proximate the roller and connected to the branch support members.
